(19) United States
(12) Patent Application Publication
(10) Pub. No.: US 2026/0338309 A1
(43) Pub. Date: Oct. 29, 2026

(54) TUBULAR CONNECTOR

(71) Applicant: VALLOUREC OIL AND GAS FRANCE, Aulnoye-Aymeries (FR)

(72) Inventors: Wolf SEIBOTH, Meudon (FR); Peter PROTZEL, Meudon (FR); Marine HUBERT, Meudon (FR)

(73) Assignee: VALLOUREC OIL AND GAS FRANCE, Aulnoye-Aymeries (FR)

(21) Appl. No.: 19/115,286

(22) PCT Filed: Oct. 25, 2023
(86) PCT No.: PCT/EP2023/079850

§ 371 Date: Mar. 26, 2025

(30) Foreign Application Priority Data
Oct. 27, 2022 (FR) FR2211220

(51) Int. Cl. F16L 41/02

(52) U.S. Cl. CPC F16L 41/021

(57) ABSTRACT

A metal tubular connector includes a first tubular component and a second tubular component, the first tubular component and the second tubular component are metallic, the first tubular component extends along a first axis, the second tubular component extends along a second axis, the first axis and the second axis intersecting, the first tubular component includes an opening, an open end of the second tubular component is contiguous with the first tubular component along a junction zone, the junction zone is delimited by the opening, the connector also includes a material deposit in the junction zone so as to provide a seal for the junction zone, the material deposit has a flat surface extending in a plane parallel to the first axis and parallel to the second axis, the flat surface is arranged in line with the junction zone.

### TECHNICAL FIELD

The invention relates to the field of tubular components used in various fields of the energy industry, such as power generation, the transport or extraction of oil, gas, and hydrogen, and in mechanical engineering. More specifically, the invention relates to a connector for such tubular components.

### TECHNOLOGICAL BACKGROUND

Metal tubes are widely used in various fields of the energy industry, such as power generation, the transport or extraction of oil, gas, and hydrogen, and in mechanical engineering.

A connector between two tubes, for example a ‘T’ connector, comprises, on the one hand, a first tube having two open ends and an opening in its wall between the two open ends and, on the other hand, a second tube having an open end complementary to the opening of the first tube. More particularly, the open end of the second tube is configured to match the shape of the first tube around the opening. This open end of the second tube is joined to the first tube by material deposition welding to ensure that the connector is sealed. Thus, the open end of the second tube opens into the first tube at the opening of the first tube between the two open ends of the first tube.

However, such a connector with a material deposit has many disadvantages.

Specifically, in the case of a connector between two metal tubes, the material deposit is made from metal at a high temperature. This high temperature of the material deposit may damage the first tube at the opening. In particular, the wall of the first tube around the opening can deform under the effect of the heat of the material deposit, for example by deforming toward the inside of the first tube. In addition, this material deposit at a high temperature can degrade the mechanical strength of the tubes at the junction. It is therefore necessary to apply a performance reduction coefficient to the connector to take into account the loss of mechanical performance due to the deposit.

It is also necessary to inspect the integrity of the material deposit after it has been made. In particular, it is important to ensure that the material deposit is free from defects such as material inclusions, cracks, or porosities. Generally speaking, any lack of uniformity in the material deposit is seen as an imperfection that is likely to adversely affect the mechanical strength of the connector in service.

This inspection must be carried out using a nondestructive process, for example by means of ultrasound sent into the material deposit and analysis of the ultrasonic waves reflected by any defects present in the material deposit. However, transmitting ultrasonic waves into the material deposit is particularly complex because the material deposit extends along the junction between the opening of the first tube and the open end of the second tube, i.e. extending both in a circumferential direction around the first tube and in a circumferential direction around the second tube. The optimum positioning of a device for transmitting ultrasonic waves and the analysis of the reflected echoes to inspect the material deposit is particularly complex.

Similarly, when the connector has to undergo surface processing, such surface processing is particularly complex to perform on the material deposit at the junction zone, as the surface processing tools are difficult to position and move along the junction zone.

There is therefore a need for a metal connector that is simple to manufacture, reliable, and easy to inspect.

### SUMMARY

One basic concept of the invention is to provide a connector between two tubular components which is simple to manufacture, reliable, and easy to inspect. In particular, one basic concept of the invention is to provide such a connector having a material deposit without detrimentally damaging the first tubular component at the junction. More particularly, one basic concept of the invention is to provide such a connector in which any damage to the first tubular component caused by the material deposit is not detrimental to the integrity of the connector. One basic concept of the invention is to provide such a connector that is easy to inspect, in particular using ultrasonic wave-based, nondestructive inspection methods. One basic concept of the invention is also to provide such a connector that is simple to manufacture. Thus, one basic concept of the invention is to provide such a connector that is easy to process using a surface processing tool, in particular at the material deposit.

According to one embodiment, the invention provides a metal tubular connector comprising a first tubular component and a second tubular component, the first tubular component and the second tubular component being metallic, the first tubular component extending along a first axis, the second tubular component extending along a second axis, the first tubular component comprising an opening, an open end of the second tubular component being contiguous with the first tubular component along a junction zone, the junction zone being delimited by the opening, the connector also comprising a material deposit in the junction zone so as to provide a seal for the junction zone, the material deposit having a flat surface extending in a plane parallel to the first axis and parallel to the second axis, the flat surface being arranged in line with the junction zone.

The junction zone means the zone defined by the respective contact surfaces of the first tubular component and the second tubular component. Thus, a material deposit at the junction zone is a material deposit on the outer surfaces of the first tubular component and of the second tubular component that are contiguous with the junction zone.

In addition, intersecting means that the first axis and the second axis intersect in the same plane or when projected into a plane parallel to the first and second axes. In other words, the first axis and the second axis are not parallel.

These features make for a reliable connector that is easy to inspect.

This is because the material deposit with a flat surface in line with the junction comprises a quantity of deposited material suitable for compensating for any deformation or degradation of mechanical performance in the junction zone of the first tubular component due to the heat produced by the material deposit.

In addition, the presence of a flat surface of the material deposit in line with the junction provides a simple surface along which to move an ultrasonic wave emitter, it being simple to move such an emitter along this flat surface.

In particular, the presence of such a flat surface parallel to both the first axis and the second axis makes it easy to position said ultrasonic-wave emitter so that the ultrasonic waves are incident on the material deposit perpendicularly to the flat surface, the ultrasonic waves thus being easier to analyze because they are not affected by reflection and incidence phenomena when they reach the flat surface.

In addition, such a flat surface is easy to process by surface processing, and in particular by surface processing requiring the movement of a tooling along the surface to be processed, for example a machining tool capable of machining the surface in order to obtain a surface of good-quality flatness to facilitate inspection via ultrasonic waves.

According to some embodiments, such a metal tubular connector may comprise one or more of the following features, alone or in combination.

According to one embodiment, the flat surface is a first flat surface, the material deposit also comprising a second flat surface, the second flat surface extending in a plane perpendicular to the first axis, the second flat surface being arranged in line with the junction zone.

As a result of these features, the positioning of an ultrasonic-wave emitting device can be easily optimized by studying the junction zone, even in zones where the thickness of the material deposit at the first flat surface is too great to be quick and reliable. Indeed, simply positioning the emitter opposite the second flat surface in the same way as it has already been positioned opposite the first flat surface also makes it possible to inspect the material deposit easily, reliably, and quickly, even in remote areas or in areas of great thickness perpendicular to the first flat surface.

According to one embodiment, the material deposit also comprises a third flat surface, the third flat surface extending in a plane perpendicular to the first flat surface and perpendicular to the second flat surface, the third flat surface being arranged in line with the junction zone.

Similarly to the second flat surface, this third flat surface makes it possible to inspect the material deposit even in remote areas or areas of great thickness perpendicular to the first flat surface and/or to the second flat surface.

According to one embodiment, the material deposit is made of metal. Such a metal deposit can be produced in numerous ways, for example by the process known as additive manufacturing or three-dimensional printing.

Such a metal-material deposit has behavioral and structural features similar to those of the first and second tubular components, ensuring good mechanical properties for the connector. In particular such a metal-material deposit makes it possible to provide a good seal while at the same time guaranteeing good mechanical strength of the connector.

According to one embodiment, the second tubular component is made of the same material as the material of the material deposit.

As a result of these features, it is possible to produce the second tubular component directly by means of the material deposit, for example by three-dimensional printing. As a result, the connector exhibits good behavioral uniformity and provides a good seal during operation. In addition, the viability of the entire material deposit, including the second tubular component, can then be inspected easily and reliably.

According to one embodiment, any point of the junction zone is arranged in line, along the first axis, with a flat surface of the material deposit. In other words, any point of the junction zone is arranged in line, along the first axis, with the second flat surface of the material deposit. According to one embodiment, the material deposit comprises a plurality of second flat surfaces. According to one embodiment, any point of the junction zone is arranged in line, along the first axis, with one of the second flat surfaces of the material deposit.

According to one embodiment, any point of the junction zone is arranged in line, along the second axis, with a flat surface of the material deposit. In other words, any point of the junction zone is arranged in line, along the second axis, with the third flat surface of the material deposit. According to one embodiment, the material deposit comprises a plurality of third flat surfaces. According to one embodiment, any point of the junction zone is arranged in line, along the second axis, with one of the third flat surfaces of the material deposit.

According to one embodiment, any point of the junction is arranged in line, perpendicularly to the first axis and perpendicularly to the second axis, with a flat surface of the material deposit. In other words, any point of the junction zone is arranged in line, perpendicularly to the first axis and perpendicularly to the second axis, with the first flat surface of the material deposit. According to one embodiment, the material deposit comprises a plurality of first flat surfaces. According to one embodiment, any point of the junction zone is arranged in line, perpendicularly to the first axis and perpendicularly to the second axis, with one of the first flat surfaces of the material deposit.

As a result of these features, it is possible to inspect the entire material deposit forming the junction between the first tubular component and the second tubular

According to one embodiment, the material deposit is solid, in a direction perpendicular to the first flat surface, between the junction zone arranged in line with the first flat surface and the first flat surface itself.

According to one embodiment, the material deposit is solid, in a direction perpendicular to the second flat surface, between the junction zone arranged in line with the second flat surface and the second flat surface itself.

According to one embodiment, the material deposit is solid in a direction perpendicular to the third flat surface, between the junction zone arranged in line with the third flat surface and the third flat surface itself.

The first tubular component and the second tubular component can take many cross-sectional shapes. According to one embodiment, the first tubular component is rotationally cylindrical. According to one embodiment, the second tubular component is rotationally cylindrical. According to one embodiment, the first tubular component and the second tubular component have the same outer and/or inner diameter. According to one embodiment, one or more of the tubular components is or are cylindrical in shape with a rectangular or square cross-section.

According to one embodiment, the first axis and the second axis are perpendicular. According to one embodiment, the first axis and the second axis form an angle of between 30° and 90° inclusive, preferably between 45° and 90° inclusive, even more preferably between 60° and 90° inclusive and ideally an angle of 90° plus or minus 5°.

According to one embodiment, the invention also provides a method for manufacturing a metal connector as above, the method comprising the steps of:
providing a first tubular component, the first tubular component comprising an opening,
providing a second tubular component, the second tubular component having an open end with a shape complementary to the shape of the opening of the first tubular component at the opening of the first tubular component,
joining the open end of the second tubular component and the first tubular component at the opening so as to delimit a junction zone between the first tubular component and the second tubular component around the opening,
depositing a material at the junction between the first tubular component and the second tubular component so as to form a material deposit which, on the one hand, seals the junction zone between the first tubular component and the second tubular component and, on the other hand, has a flat surface in line with the junction zone.

### BRIEF DESCRIPTION OF THE FIGURES

The invention will be better understood, and further objects, details, features, and advantages of the invention will become clearer in the following description of several particular embodiments of the invention, which are given only by way of illustration and not in a limiting manner, with reference to the appended drawings.

FIG. 1 is a schematic perspective view of a tubular connector according to the invention.

FIG. 2 is a schematic perspective cross-section of the connector from FIG. 1.

FIG. 3 is a cross-section of the connector from FIG. 1 similar to FIG. 2

FIG. 4 is a schematic perspective cross-section of the connector from FIG. 1 from a different viewing angle to FIG. 2.

FIG. 5 is a schematic perspective view of a tubular connector between a plurality of tubular components according to one variant embodiment of the invention.

### DESCRIPTION OF THE EMBODIMENTS

Extracting oil, gas, and other products requires a large number of tubular components, also known as tubes. As a result of the many stresses to which these tubular components are subjected, both during installation and operation, they have to comply with standards to prevent any damage or leakage into the environment. Some tubular components are connected to one another end-to-end, but it may be necessary to join two tubular components via a connector. In such a connector, one tubular component opens into another tubular component between the two open ends of the other tubular component.

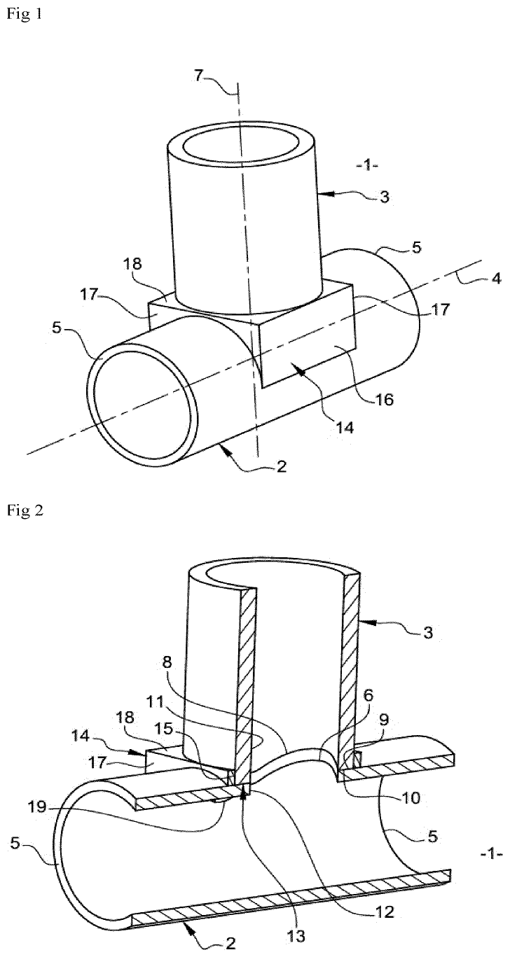

FIG. 1 shows a tubular connector 1 according to the invention. Such a tubular connector 1 comprises a first tubular component 2 and a second tubular component 3.

In this FIG. 1, the first tubular component 2 has a first longitudinal axis 4.

In FIG. 1, the first tubular component 2 has a short length with two open ends 5, but this first tubular component 2 could of course have a greater length and have features such as threads or the like (not shown here for the sake of simplicity) enabling it to be connected to other tubular components.

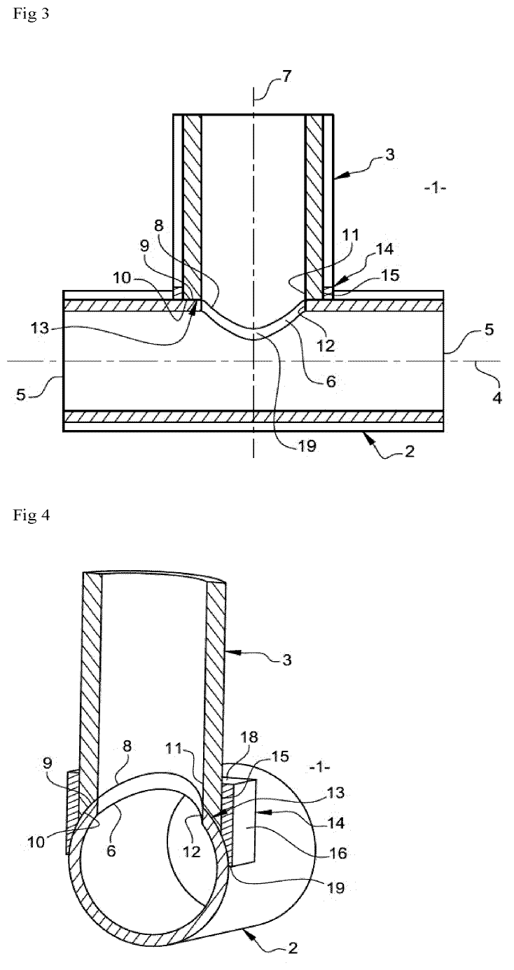

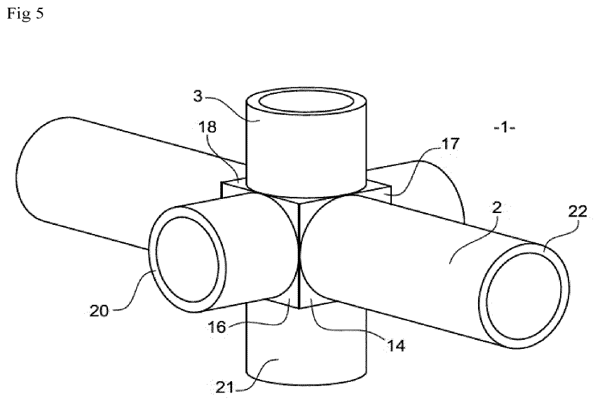

The first tubular component 2 comprises an opening 6 (see FIGS. 2 to 4) arranged between the ends 5 in a wall forming the first tubular component 2. This opening 6 passes through the wall of the first tubular component 2.

The second tubular component 3 has a second longitudinal axis 7. This second axis 7 forms an angle with the first axis 4, this angle being 90° on the connector shown in FIGS. 1 to 4.

The second tubular component 3 comprises an open end 8. This open end 8 opens into the first tubular component 2 via the opening 6. Thus, an edge face 9 of the second tubular component 3 at the open end 8 has a shape identical to the shape of an outer surface 10 of the first tubular component 2 surrounding the opening 6. Thus, an inner surface 11 of the second tubular component 3 is flush with an edge face 12 of the first tubular component 2 delimited by the opening 6. The contact zone between the edge face 9 of the second tubular component 3 and the outer surface 10 of the first tubular component 2 thus forms a junction zone 13 between the first tubular component 2 and the second tubular component 3.

In order to make the junction zone 13 between the first tubular component 2 and the second tubular component 3 secure and sealed, a weld is made at the junction zone 13. This weld is made by a material deposit 14 resting jointly against the outer surface 10 of the first tubular component 2 and against an outer surface 15 of the second tubular component 3 in line with the junction zone 13.

As shown in FIGS. 1 to 4, the material deposit 14 is not a simple layer covering the first tubular component 2 and the second tubular component 3 at the junction 13 but forms a volume of material surrounding the tubular components 2 and 3 at the junction zone 13. In this way, the material deposit 14 has a substantially cuboid shape around the junction zone 13.

The material deposit 14 thus has first flat surfaces 16, second flat surfaces 17, and third flat surfaces 18.

The first flat surfaces 16 extend in a plane parallel to the first axis 4 and parallel to the second axis 7. The second flat surfaces 17 extend in a plane perpendicular to the first axis 4. The third flat surfaces 18 extend in a parallel plane perpendicular to the first flat surfaces 16 and perpendicular to the second flat surfaces 17. In other words, with a first axis 4 and a second axis 7 perpendicular to each other, as shown in FIGS. 1 to 4, the third flat surfaces 18 extend perpendicularly to the second axis 7.

Such flat surfaces 16, 17 and 18 enable the quality of the material deposit 14 to be inspected quickly and easily. Such flat surfaces 16, 17 and 18 can therefore be examined easily and quickly, for example by an ultrasound-based, nondestructive inspection to detect any defects in the material deposit 14.

Such a material deposit 14 is made by depositing successive layers of metal along the second axis 7 from a distal end 19 of the junction zone 13 until the junction zone 13 is completely covered. As a result, each layer of the material deposit 14 has a greater thickness along the first axis 4, and also perpendicularly to the first axis 4 and perpendicularly to the second axis 7, than the previous layer.

Such a material deposit 14 is made, for example, by three-dimensional printing, a process known as additive manufacturing.

The material used to form the material deposit 14 is preferably metal, for example carbon steel or stainless steel, or any other weldable metal such as an aluminum or titanium alloy.

The fact that the material deposit 14 is not limited to a simple layer covering the junction zone 13 provides an increasing deposit surface area and thus allows increasing stability of the successive layers of the material deposit 14, each successive layer resting on a larger surface area of material than the previous one.

In addition, such a material deposit 14 having such flat surfaces 16, 17 and 18 can be processed easily and quickly, for example by machining, to ensure good flatness of the flat surfaces 16, 17 and 18. Indeed, a tooling intended to process the flat surfaces 16, 17 and 18 simply has to move in a plane corresponding to the flat surface 16, 17 or 18 being processed, without having to be moved along a complex trajectory to follow the junction zone 13.

FIG. 5 shows a variant embodiment of the invention in which a plurality of tubular components is connected to form a connector. In FIG. 5 and in the description below, elements which are identical to and/or perform the same function as the elements described above in relation to FIGS. 1 to 4 have the same references.

In FIG. 5, in addition to the first tubular component 2 and the second tubular component 3, the connector 1 also comprises a third tubular component 20, a fourth tubular component 21, and a fifth tubular component 22. The first tubular component 2 thus comprises a plurality of openings 6 (not shown in FIG. 5). Each opening 6 forms a respective junction zone 13 (not shown in FIG. 5) with one of the second tubular component 3, the third tubular component 20, the fourth tubular component 21, and the fifth tubular component 22. The material deposit 14 in this embodiment is cuboidal as explained above so as to form flat surfaces 16, 17 and 18 surrounding all the junction zones 13.

Although the invention has been described in relation to a number of particular embodiments, it is clear that it is by no means limited to these and that it consists of all the technical equivalents of the means described, as well as combinations thereof if these fall within the scope of the invention.

Thus, the embodiments shown in FIGS. 1 to 5 have tubular components having axes which are perpendicular; however, the connector can be formed from tubular components having axes which are not perpendicular, for example are at 60°. In this case, the material deposit remains preferably cuboid in shape around the junction zone.

The first and second axes may intersect, in a plane formed by the first and second axes or when projected into a plane parallel to the first and second axes. The first axis and the second axis cannot be parallel.

Similarly, the tubular components shown above have substantially the same diameters. However, the tubular component opening into the other tubular component could have a smaller diameter.

In addition, the junction zone shown in FIGS. 1 to 4 is formed by the outer surface of the first tubular component on which the second tubular component rests. However, this junction zone could be formed by the edge face 12 of the opening 6 and the outer surface of the second tubular component, the end of the second tubular component being inserted into the opening 6 to open into the first tubular component 2.

The use of the verbs “comprise”, “consist of,” or “include” and their conjugated forms does not exclude the presence of elements or steps other than those set out in a claim.

In the claims, any reference signs between brackets should not be interpreted as a limitation of the claim.

1. A metal tubular connector comprising a first tubular component and a second tubular component, the first tubular component and the second tubular component being metallic, the first tubular component extending along a first axis, the second tubular component extending along a second axis, the first axis and the second axis intersecting, the first tubular component comprising an opening, an open end of the second tubular component being contiguous with the first tubular component along a junction zone, the junction zone being delimited by the opening, the connector also comprising a material deposit in the junction zone so as to provide a seal for the junction zone, the material deposit having a flat surface extending in a plane parallel to the first axis and parallel to the second axis, the flat surface being arranged in line with the junction zone.

2. The metal tubular connector as claimed in claim 1, wherein the flat surface is a first flat surface, the material deposit also comprising a second flat surface, the second flat surface extending in a plane perpendicular to the first axis, the second flat surface being arranged in line with the junction zone.

3. The metal tubular connector as claimed in claim 2, wherein the material deposit also comprises a third flat surface, the third flat surface extending in a plane perpendicular to the first flat surface and perpendicular to the second flat surface, the third flat surface being arranged in line with the junction zone.

4. The metal tubular connector as claimed in claim 1, wherein the material deposit is made of metal.

5. The metal tubular connector as claimed in claim 1, wherein the second tubular component is made of the same material as the material of the material deposit.

6. A method for manufacturing a metal tubular connector as claimed in claim 1, comprising the steps of:
a. providing a first tubular component, the first tubular component comprising an opening,
b. providing a second tubular component, the second tubular component having an open end with a shape complementary to the shape of the first tubular component at the opening of the first tubular component,
c. joining the open end of the second tubular component and the first tubular component at the opening so as to delimit a junction zone between the first tubular component and the second tubular component around the opening,
d. depositing a material in the junction zone between the first tubular component and the second tubular component so as to form a material deposit which, on the one hand, seals the junction zone between the first tubular component and the second tubular component and, on the other hand, has a flat surface in line with the junction zone.
